(19) United States
(12) Patent Application Publication
(10) Pub. No.: US 2023/0373299 A1
(43) Pub. Date: Nov. 23, 2023

(54) DEVICE AND METHOD FOR CONTROLLING THE DISPLAY OF INFORMATION IN THE FIELD OF VISION OF A DRIVER OF A VEHICLE

(71) Applicant: EYELIGHTS, LABEGE (FR)

(72) Inventors: Patrice NAGTEGAELE, TOULOUSE (FR); Romain DUFLOT, TOULOUSE (FR)

(21) Appl. No.: 18/030,998

(22) PCT Filed: Oct. 8, 2021
(86) PCT No.: PCT/FR2021/051749

§ 371 Date: Apr. 9, 2023

(30) Foreign Application Priority Data
Oct. 13, 2020 (FR) 2010460

(51) Int. Cl. B60K 35/00; B60W 40/08

(52) U.S. Cl. CPC B60K 35/00; B60W 40/08; B60K 2370/186; B60K 2370/164; B60K 2370/334; B60K 2370/1529; B60K 2370/736; B60W 2540/22; B60W 2540/229

(57) ABSTRACT

A device to control the display of information in a field of vision of a driver of a vehicle. A memory to store a table associating different classes of display with respective threshold values of an attention score representative of a level of attention of the driver. One or more processors configured to: collect information to be displayed in the field of vision of the driver, each piece of information belonging to a display class, collect attention information relating to the level of attention of the driver, and calculate an attention score representative of a level of attention of the driver from the collected attention information. For each piece of information: the processor is configured to compare the calculated attention score to the threshold value associated with the display class to which the information belongs, and to determine whether to display the piece of information depending on the comparison result.

### FIELD OF INVENTION

The present invention relates to the field of displaying information in the field of vision of a driver of a means of locomotion. The invention relates in particular to a device and a method for controlling the display of information in the field of vision of the driver in order to enhance safety when driving the means of locomotion.

### BACKGROUND OF THE INVENTION

Recent technological advances and cost reductions in screens and display systems are leading to the integration of increasingly large and numerous screens into motor vehicle instrument panels.

Head-up displays (HUDs) are also known to be used to superimpose information on the outside environment by generating a virtual image using a transparent projection medium such as a windscreen or a transparent, semi-reflective screen placed between the windscreen and the driver (semi-reflective pane for a head-up display known as a “combiner”).

This all contributes to displaying increasing amounts of information in the field of vision of the driver (information on the operating status of the vehicle, on navigation, on environmental conditions outside the vehicle, on points of interest in the vicinity of the vehicle, short text-based messages or e-mails addressed to the driver, news or social network articles, or entertainment information, etc.). However, while some information displayed in the field of vision of the driver can increase driver alertness and thus enhance driving safety, other information constitutes a distraction which lowers driver alertness and thus reduces driving safety.

Several sources of driver distraction have now been identified: auditory distraction (attention is diverted towards things that we hear), visual distraction (attention is diverted towards things that we see), physical distraction (attention is diverted towards things that we do) and cognitive distraction (attention is diverted towards things that we think about). Auditory distraction corresponds, for example, to having a telephone conversation or a discussion with other passengers in the vehicle. Visual distraction corresponds, for example, to taking your eyes off the road in favour of a task unrelated to driving (for example looking for your mobile phone inside the passenger compartment of the vehicle). Physical distraction corresponds, for example, to handling a mobile phone instead of holding the vehicle's steering wheel with both hands. Cognitive distraction corresponds, for example, to thinking about a message you want to write on your mobile phone rather than analysing the traffic conditions. In addition to this, the driver's behaviour is affected by the fear of missing out (FOMO syndrome), which increases the frequency of sources of distraction (for example the driver will regularly look at and/or handle his/her mobile phone to check whether he/she has received a call or a message).

The amount and nature of the information displayed in the field of vision of the driver must thus be controlled in order to improve driving safety. Conventionally, predetermined display configurations define what information is to be displayed and where it is to be displayed in the field of vision of the driver. These configurations are typically preconfigured, but they can also be configured by the driver. However, these display configurations are fixed and do not allow dynamic control of the information to be displayed, taking into account, in real time, the conditions in which the driver finds himself/herself (traffic conditions, condition of the vehicle, physiological and/or psychological state of the driver, etc.).

Generally speaking, existing solutions do not allow a satisfactory compromise to be reached for giving the driver access to as much information as possible while guaranteeing driving safety.

### OBJECT AND SUMMARY OF THE INVENTION

The purpose of the present invention is to overcome all or part of the drawbacks of the prior art, in particular those described hereinabove.

To this end, and according to a first aspect, the present invention proposes a device for controlling the display of information in a field of vision of a driver of a means of locomotion. The device includes a memory storing a table associating different classes of display with respective threshold values of an attentional score representative of a level of attention of the driver. The device further includes one or more processors configured for:
collecting one or more pieces of information to be displayed in the field of vision of the driver, each piece of information to be displayed belonging to a display class of said table,
collecting one or more pieces of attentional information relating to the level of attention of the driver,
calculating an attentional score representative of the level of attention of the driver from the collected pieces of attentional information,
for each piece of information to be displayed:
   comparing the calculated attentional score with the threshold value associated with the display class to which said piece of information to be displayed belongs,
   deciding whether or not to display said piece of information to be displayed based on the result of said comparison.

The invention is particularly applicable to the case where the means of locomotion are a motor vehicle. The information to be displayed can, for example, be displayed on a screen integrated into the instrument panel of the vehicle. This can in particular include a Liquid Crystal Display (LCD), and more particularly a Thin Film Transistor (TFT) display, which can optionally be transparent.

According to another example, the information to be displayed can be displayed in the field of vision of the driver by a head-up display. In such a case, the information to be displayed can be projected onto the windscreen in order to appear to the driver in the form of a virtual image behind the windscreen and superimposed on the outside environment within the field of vision of the driver. Alternatively, the information to be displayed can be projected by the head-up display to a “combiner” in the form of a transparent, semi-reflective screen positioned between the driver and the windscreen.

It should be noted, however, that the invention can be applied to any type of means of locomotion as long as information can be displayed to the driver of said means of locomotion. The information can, for example, be displayed on an on-board screen of the means of locomotion. However, the information can also be displayed in the field of vision of the driver of the means of locomotion via a head-up display device embedded in a helmet, a mask, a pair of goggles or a pair of spectacles worn by the driver. The invention can thus be applied to any type of means of locomotion: car, lorry, motorbike, bicycle, scooter, skis, snowboard, aeroplane, or boat, etc. It should be noted that the term “means of locomotion” also encompasses, as additional examples, a scuba diving suit or a spacesuit. More specifically, such suits are equipment items that allow an individual to move within a particular environment (deep sea, outer space, etc.). The term “driver” must thus be understood to mean the individual using or controlling the means of locomotion in order to make the desired movement.

The device according to the invention can be a physical entity integrated into the means of locomotion (for example a control unit fitted during first assembly, or a retrofitted device), but can also be a device that is separate from the means of locomotion, for example a device worn by the driver (for example a control unit integrated into a helmet, a mask, a pair of goggles or a pair of spectacles of the driver, or a mobile phone, etc.).

The “field of vision of the driver” is understood to mean the portion of space that the driver can see while driving without having to move his/her head significantly. The field of vision of the driver thus encompasses the space that the driver can see simply by moving his/her eyes without moving his/her head, as well as the space that the driver can see when moving his/her head by an amplitude of head movement that remains natural for a driver.

The information to be displayed is classified, according to its nature, into different information classes. The information to be displayed can relate to driving safety. The information to be displayed can also be unrelated to driving. Information classes are listed below for the case of a motor vehicle, by way of example and are not limiting:
safety-related information on an operating status of the vehicle (tyre pressure, engine temperature, oil level, airbag or seatbelt activation status notifications, autonomous driving level, etc.),
safety-related information on environmental conditions external to the vehicle (hazardous weather conditions, uneven, wet or icy roads, areas considered hazardous due to roadworks or accidents, speed limit, etc.),
non-safety-related information on an operating status of the vehicle (temperature in the passenger compartment, ventilation power level and orientation, control information for lighting in the passenger compartment, etc.),
non-safety-related information on environmental conditions outside the vehicle (outside air temperature, weather forecast, traffic conditions, etc.),
navigation information provided by a global positioning system,
notification of an incoming telephone call,
short text-based message,
email message,
information about the music being played,
social network articles,
videos,
etc.

Other examples of information classes to be displayed can also be considered depending on the means of locomotion concerned. For example, if the means of locomotion is a diving suit or a spacesuit, one information class can correspond to information on an operating status of the suit (level of available oxygen, pressure experienced by the user, etc.).

Each display class is associated with a threshold value of an attentional score representative of a level of attention of the driver. The attentional score is, for example, representative of the attention resources of the driver that are available for non-driving related tasks without compromising safety. In such a case, the attentional score is higher when driving conditions are easy (light traffic, good weather conditions, low speed, high driving automation level, satisfactory physiological state of the driver, etc.). According to another example, the attentional score is representative of the attention resources of the driver that are required to ensure satisfactory driving safety. In such a case, the attentional score is higher when driving conditions are difficult (heavy traffic, poor weather conditions, low driving automation level, significant driver fatigue, etc.). Thus, there are various ways to define an attentional score that is representative of a driver's level of attention. The various ways of defining the attentional score merely constitute alternative embodiments of the invention.

The threshold value associated with a display class depends on the nature of the information belonging to said class. For example, for a display class containing information relevant to driving safety, a threshold value should be defined that allows the information to be displayed even if the attention resources of the driver are already mostly monopolised by driving. Conversely, for a display class containing non-driving related information, a threshold value should be defined that only allows the information to be displayed if the attention resources of the driver can be allocated to non-driving related tasks without compromising driving safety.

The attentional score is calculated from attentional information regarding the level of attention of the driver. Attentional information can, in particular, be representative of a physiological or psychological state of the driver (heart rate, body temperature, pupil or eyelid movement, or a psychological profile of the driver predefined and stored in memory by the device, are all examples of information that can be used to determine a level of attention of the driver). Attentional information can also be representative of an operating status of the means of locomotion (for example if the speed is high, if the driving automation level is low, and/or if one or more elements of the means of locomotion are defective, then the attention resources of the driver that must be reserved for driving are higher). Attentional information can also be representative of environmental conditions outside the means of locomotion (for example in the case of heavy rain or dense fog, the attention resources of the driver that can be available for non-driving related tasks are lower).

Attentional information can be acquired by means of a sensor belonging to the device according to the invention, or by a sensor belonging to an entity that is separate from the device according to the invention (for example a mobile phone, a connected object such as a smart watch, a GPS receiver on board the means of locomotion, a heart rate monitor integrated into the means of locomotion or into the smart watch, or a camera and an image analysis module for analysing the movements of the driver's eyes and eyelids, etc.). The device can in particular include a communication module for receiving attentional information acquired by sensors belonging to entities that are separate from the device.

The information to be displayed in the field of vision of the driver can originate from various sources: mobile phone, smart watch, multimedia system on board the means of locomotion, diagnostic system on board the means of locomotion, etc. The device can in particular include a communication module for receiving information to be displayed from these various sources. The various sources can correspond to systems installed on first assembly (i.e. directly assembled on the means of locomotion during the manufacture thereof) or retrofitted (i.e. added after the means of locomotion have been purchased).

It should be noted that the information to be displayed does not typically relate to the attentional information. In other words, the nature of the information to be displayed is typically independent of the attentional information (the nature of the information to be displayed is unrelated to the attentional information). In such a case, only the decision on whether or not to display the information to be displayed is dependent on the attentional information. In specific implementations, at least one piece of information to be displayed is unrelated to the attentional information used to calculate the attentional score.

For each piece of information to be displayed, the threshold value associated with the display class to which said information to be displayed belongs is compared with the attentional score calculated for the driver. A decision on whether or not to display the information to be displayed is then made based on the result of the comparison. A positive decision means that the information to be displayed can be displayed in the field of vision of the driver. A negative decision means that the information to be displayed must not be displayed in the field of vision of the driver. In the case of a positive decision, the display of the information can be further contingent upon the verification of a legal constraint.

Such dispositions allow a good compromise to be reached for giving the driver access to as much information as possible while guaranteeing driving safety.

In particular embodiments, the invention may also include one or more of the following features, considered separately or according to any technically-feasible combination.

In specific embodiments, the device further includes at least one sensor for acquiring attentional information relating to the level of attention of the driver.

In specific embodiments, the device further includes a communication module for receiving at least one piece of attentional information acquired by a sensor belonging to an entity that is separate from the device.

In specific embodiments, the device further includes an image generator adapted to generate an image intended to be projected onto a transparent projection medium to form, by reflection on the projection medium, a virtual image appearing behind the projection medium for the driver. The virtual image thus formed contains the information to be displayed for which the decision on whether to display is positive.

In specific embodiments, when there are several pieces of information to be displayed, the one or more processors are further configured to order the pieces of information to be displayed by an order of priority, and to make decisions as to whether or not to display said pieces of information successively based on said order of priority.

More specifically, when there is more than one piece of information to be displayed, displaying a particular piece of information can affect the attention resources of the driver (the number of pieces of information displayed can be viewed as attentional information). As a result, displaying one piece of information can have an effect on the decision on whether to display another piece of information. The pieces of information to be displayed are thus advantageously ordered according to an order of priority and the decisions on whether or not to display said information successively are advantageously made based on said order of priority. It is understood in this respect that a new attentional score value is calculated for each decision to be made, as the decision on whether or not to display high-priority information can impact the attentional score value used for the decision on whether or not to display lower-priority information. For example, information relevant to driving safety can be given a priority order that is higher than that of non-driving-related information. According to another example, a higher priority can be assigned to information originating from a specific source (incoming call, SMS message or e-mail from a specific, predetermined contact). The priority levels can be defined per display class. Alternatively or additionally, priority levels with a finer granularity can be defined within the same display class.

According to a second aspect, the present invention relates to a head-up display including a device according to any one of the preceding embodiments with an image generator. The head-up display further includes a transparent projection medium. The image generator projects an image onto the transparent projection medium in order to generate a virtual image that appears behind the projection medium to the driver, by reflection on the projection medium.

In specific embodiments, the transparent projection medium is a windscreen of a vehicle or a transparent projection screen placed between the driver and the windscreen.

In specific embodiments, the transparent projection medium is a visor or screen of a helmet or a mask, or an eyeglass lens. By way of non-limiting examples, the transparent projection medium can correspond to the visor of a motorbike helmet, or a face plate of a scuba diving mask, or a screen of a scuba diving or spacesuit helmet, or a screen of a ski mask, etc.

According to a third aspect, the present invention relates to a decision-making method for controlling the display of information in a field of vision of a driver of a means of locomotion. The method is implemented by a device according to any of one of the preceding embodiments. The method includes the following steps:
collecting one or more pieces of information to be displayed in the field of vision of the driver, each piece of information to be displayed belonging to a display class of the table stored in the memory of the device,
collecting one or more pieces of attentional information relating to the level of attention of the driver,
calculating an attentional score representative of the level of attention of the driver from the collected pieces of attentional information,
for each piece of information to be displayed:
   comparing the calculated attentional score with the threshold value associated with the display class to which said piece of information to be displayed belongs,
   deciding whether or not to display said piece of information to be displayed based on the result of said comparison.

In particular embodiments, the invention may further include one or more of the following features, considered separately or according to any technically-feasible combination.

In specific implementations, attentional information is representative of a physiological or psychological state of the driver, of an operating status of the means of locomotion, or of environmental conditions outside the means of locomotion.

In specific implementations, a display class corresponds to one of the following classes:
information on an operating status of the means of locomotion relevant to driving safety,
information on environmental conditions outside the means of locomotion and relevant to driving safety,
information on an operating status of the means of locomotion not relevant to driving safety,
information on environmental conditions outside the means of locomotion and not relevant to driving safety,
navigation information,
notification of an incoming telephone call,
short text-based message,
email message,
information about the music being played,
social network articles,
video.

In specific implementations, the attentional score is representative of a level of attention available to the driver for viewing information displayed in the field of vision thereof without compromising the safe driving of the means of locomotion.

In specific implementations, the decision on whether to display a piece of information to be displayed is positive when the calculated attentional score is greater than or equal to the threshold value associated with the display class to which said information to be displayed belongs.

In specific implementations, when there is more than one piece of information to be displayed, the information to be displayed is ordered according to an order of priority, and the decisions as to whether or not to display said information are made in succession based on said order of priority.

According to a fourth aspect, the present invention relates to a computer program product, characterised in that it includes a set of program code instructions which, when executed by one or more processors, configure the one or more processors to implement a method according to any one of the preceding implementations.

### BRIEF DESCRIPTION OF THE FIGURES

The invention will be better understood upon reading the following description, given as a non-limiting example, and made with reference to FIGS. 1 to 3 which represent:

FIG. 1 is a diagrammatic view of a motor vehicle in which a device according to the invention is embedded in order to control the display of information within the field of vision of the driver,

FIG. 2 is a diagrammatic view of a device according to the invention and of various sensors configured to acquire attentional information relating to a level of attention of the driver,

FIG. 3 is a diagrammatic view of the main steps of a method for controlling the display of information within the field of vision of the driver.

In these figures, identical references from one figure to another refer to identical or similar elements. For clarity, the represented elements are not necessarily plotted to the same scale, unless stated otherwise.

### DETAILED DESCRIPTION OF AN EMBODIMENT OF THE INVENTION

As mentioned hereinabove, the present invention aims to provide a solution for controlling the display of information within a field of vision of a driver of a means of locomotion, so as to find a satisfactory compromise for giving the driver access to as much information as possible while guaranteeing safe driving.

In the description hereafter, the case considered, in a non-limiting manner, is that in which the means of locomotion are a motor vehicle.

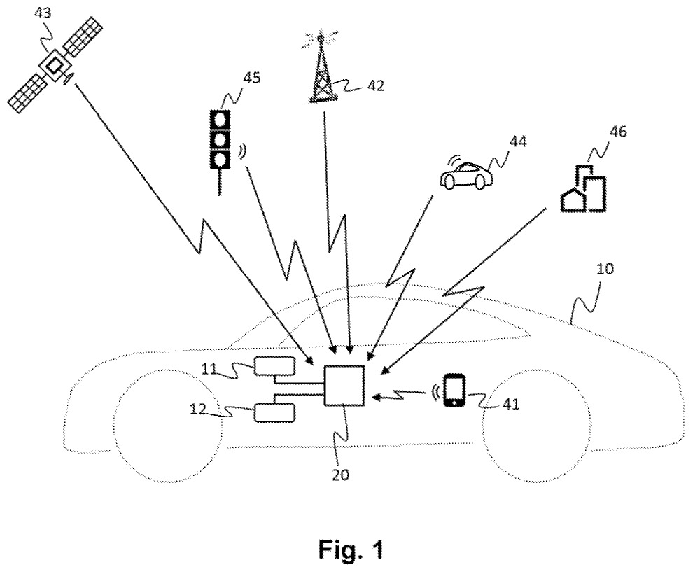

FIG. 1 shows a motor vehicle 10 in which a device 20 according to the invention is embedded in order to control the display of information within the field of vision of the driver of the vehicle 10.

As illustrated in FIG. 1, the information to be displayed can originate from a variety of sources.

In particular, information to be displayed can originate from a mobile phone 41 located inside the vehicle 10 (for example the mobile phone of the driver). For example, a piece of information to be displayed within the field of vision of the driver can correspond to a text message (or SMS messages (Short Message Service)), an email, a social network article, a news item, the day's weather forecast, an entertainment video, a navigation aid, a notification of an incoming telephone call, or information relating to an electronic calendar, etc. The information to be displayed is, for example, received by the device 20 from the mobile phone 41 by communicating via a wireless communication protocol (for example Bluetooth®, Wi-Fi®, RFID, or Zigbee®, etc.) or a wired communication protocol (for example USB). USB is the acronym for “Universal Serial Bus”. RFID is the acronym for “Radio Frequency Identification”.

A piece of information to be displayed within the field of vision of the driver can further correspond to a piece of information originating from an on-board diagnostics system (OBD) 11 of the vehicle 10. A diagnostics system 11 monitors vehicle operation and diagnoses failures. This information on the operating status of the vehicle typically concerns driving safety (tyre pressure, engine temperature, oil level, engine failure, etc.).

A piece of information to be displayed within the field of vision of the driver can further correspond to a piece of information originating from an on-board multimedia system 12 of the vehicle 10.

The device 20 can, in particular, be connected to the multimedia system 12 or to the diagnostics system 11 via a CAN (Controller Area Network) data bus or via a wireless communication protocol (for example Bluetooth® or Wi-Fi®).

A piece of information to be displayed within the field of vision of the driver can also be received directly by the device 20 from an access network 42 of a wireless communication system (for example a 3G, LTE or 5G cellular network) or from a Global Navigation Satellite System (GNSS) 43.

A piece of information to be displayed can also be received by the device via communication with another vehicle of a network 44 V2V (V2V being the acronym for “Vehicle-to-Vehicle”, and is a radiofrequency technology dedicated to communication between vehicles), or via communication with a roadside infrastructure of a network 45 V2I (V2I being the acronym for “Vehicle-to-Infrastructure”, and is a radiofrequency technology dedicated to communication between a vehicle and roadside infrastructures). More specifically, a neighbouring vehicle can communicate its status to the vehicle 10. This allows, for example, a neighbouring vehicle to alert the driver of the vehicle 10 to an imminent danger (emergency braking of a neighbouring vehicle in front, detection of neighbouring vehicles arriving at a junction, etc.). The vehicle 10 can also receive information originating from connected roadside infrastructures comprising wireless communication means: for example a traffic light capable of communicating its status to the vehicle 10, or a speed limit sign capable of communicating the speed limit to the vehicle 10.

A piece of information to be displayed can also be received by the device from a wireless sensor network 46 of the “smart city” type.

In order to support these various examples, the device 20 can include a communication module that is compatible, in a conventional manner, with the one or more communication protocols that allow it to receive the information to be displayed sent by the various information sources.

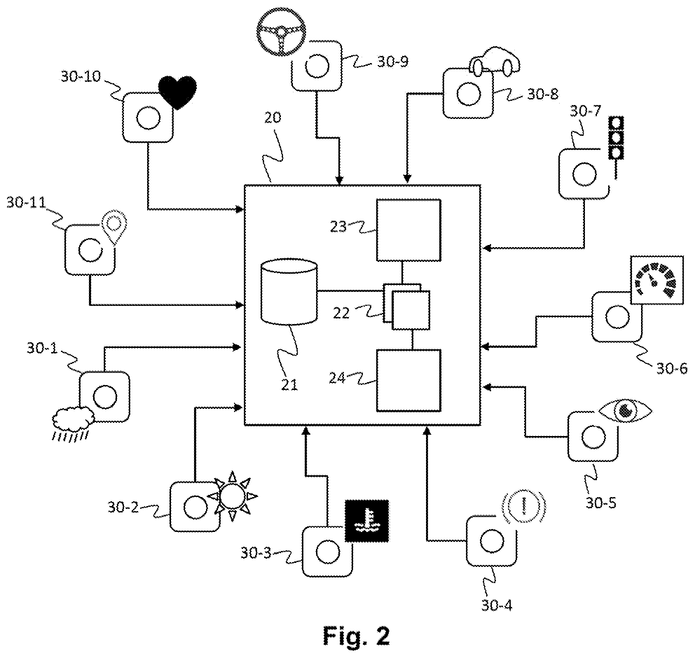

FIG. 2 diagrammatically shows an example embodiment of a device 20 according to the invention.

The device 20 includes an electronic memory 21 (magnetic hard disk, electronic memory, optical disk, etc.) in which a table with different display classes is stored. The different display classes allow the information to be displayed to be classified according to the nature thereof. For example, a first display class groups together information to be displayed on the operating status of the vehicle and relevant to driving safety (tyre pressure, engine temperature, oil level, airbag or seatbelt activation status notifications, etc.); a second display class groups together information to be displayed on the environmental conditions external to the vehicle and relevant to driving safety (hazardous weather conditions, uneven, wet or icy roads, areas considered hazardous due to roadworks or accidents, speed limit, etc.); a third display class groups together information to be displayed on the operating status of the vehicle and not relevant to safety (temperature in the passenger compartment, ventilation power level and orientation, control information for lighting in the passenger compartment, etc.); a fourth display class groups together information to be displayed on the environmental conditions outside the vehicle and not relevant to driving safety (outside air temperature, weather forecast, traffic conditions, etc.); a fifth display class groups together information to be displayed on navigation; a fifth display class corresponds to the notification of an incoming telephone call; a sixth display class groups together short text-based messages (SMS or social media messages); a sixth display class groups together long text-based messages (emails, news articles); a seventh display class groups together information on the music being played; an eighth display class groups together entertainment videos (film).

It should be noted that the display classes described hereinabove are given as non-limiting examples, and that other display classes could be defined for the implementation of the invention. A specific choice of a set of display classes merely constitutes an alternative embodiment of the invention.

In the table, each display class is associated with a threshold value of an attentional score representative of a level of attention of the driver. The attentional score is, for example, representative of the attention resources of the driver that are available for non-driving related tasks without compromising safety. According to another example, the attentional score is representative of the attention resources of the driver that are required to ensure satisfactory driving safety. The threshold value associated with a display class depends on the nature of the information belonging to said class.

The attentional score of the driver is calculated from one or more pieces of attentional information regarding the level of attention of the driver. These pieces of attentional information are acquired by various sensors 30. According to various embodiments, the sensors 30 can be integrated into the device 20 according to the invention, or the sensors 30 can belong to separate entities (for example a sensor integrated into the mobile phone 41, a sensor integrated into or connected to the on-board diagnostics system 11 of the vehicle 10, a sensor integrated into or connected to the on-board multimedia system 12 of the vehicle 10, an autonomous sensor integrated into the vehicle 10 and connected to the device 20, or a sensor integrated into a connected object worn by the driver, etc.).

When the sensors belong to separate entities, the device includes a communication module 23 for receiving attentional information acquired by said sensors. The communication module is configured to be compatible, in a conventional manner, with various radio technologies (Wi-Fi®, Bluetooth®, RFID®, Zigbee®, etc.), and/or various wired technologies (USB, CAN, etc.) as well as the communication protocols associated with said technologies. The same communication module 23 can be used to collect the information to be displayed as described with reference to FIG. 1.

FIG. 2 shows various sensors 30 for acquiring attentional information regarding the level of attention of the driver.

Some sensors 30 allow attentional information regarding the operating status of the vehicle to be acquired (if the operating status of the vehicle is compromised, the level of attention resources that must be reserved to ensure safe driving is greater). This is the case, for example, for the engine temperature sensor 30-3, the engine failure sensor 30-4, or the speed sensor 30-6 of the vehicle 10. When a vehicle failure is detected and/or when the speed of the vehicle 10 is high, more of the driver's attention resources must be reserved for driving in order to ensure safe driving. Moreover, the sensor 30-9 indicates the level of autonomous driving currently activated for the vehicle 10. More specifically, the SAE (Society of Automotive Engineers) defines different levels of autonomous driving: level 0, where the driver remains responsible for controlling the vehicle; level 1, where the driver is assisted by the vehicle; level 2, where driving automation is partial; level 3, where driving automation is conditional; level 4, where driving automation is significant; and level 5 with full driving automation. The higher the driving automation level, the more of the driver's attention resources are available for tasks that are unrelated to driving.

Other sensors 30 can be used to acquire attentional information about the driver's physiological or psychological state. This is the case for the heart rate monitor 30-10, which is, for example, integrated into the steering wheel of the vehicle 10 or into a smart watch worn by the driver. This is also the case for the fatigue sensor 30-5, which integrates, for example, a camera and an image analysis module to analyse the driver's behaviour (blinks, yawns, head tilt, direction of gaze, etc.) and/or a detector for detecting the driver's movements of the steering wheel (when the driver is tired, the corrections made to the steering wheel to keep the vehicle in lane generally become less frequent and more abrupt). Optionally, a psychological profile of the driver stored in the memory 21 of the device 20 can also provide attentional information relating to the psychological state of the driver (for example a profile reporting a behavioural disorder of the driver). When the physiological or psychological state of the driver is poor, more of the driver's attention resources must be reserved for driving in order to ensure safe driving.

Other sensors 30 can be used to acquire attentional information about the environmental conditions outside the vehicle. This is the case, for example, for the GNSS sensor 30-11, the rain sensor 30-1, the light sensor 30-2, the sensor 30-7 configured to receive information sent by a roadside infrastructure (V2I), or the sensor 30-8 configured to receive information sent by another vehicle (V2V). When the environmental conditions are poor (hazardous weather conditions, night-time driving, heavy traffic, etc.) more of the driver's attention resources must be reserved for driving in order to ensure safe driving.

As illustrated in FIG. 2, the device 20 includes one or more processors 22 configured to execute a computer program product to implement a decision-making method for controlling the display of information within the field of vision of the driver. The computer program product is stored, for example, in the form of program code instructions in the memory 21 of the device 20. Alternatively or additionally, the device 20 includes one or more programmable logic devices, of the FPGA or PLD type, etc., and/or application-specific integrated circuits (ASIC) adapted to implement the steps of said decision-making method (in other words, the device 20 includes a set of means configured in software form (specific computer program product) and/or hardware form (FPGA, PLD, ASIC, etc.) to implement the decision-making method.

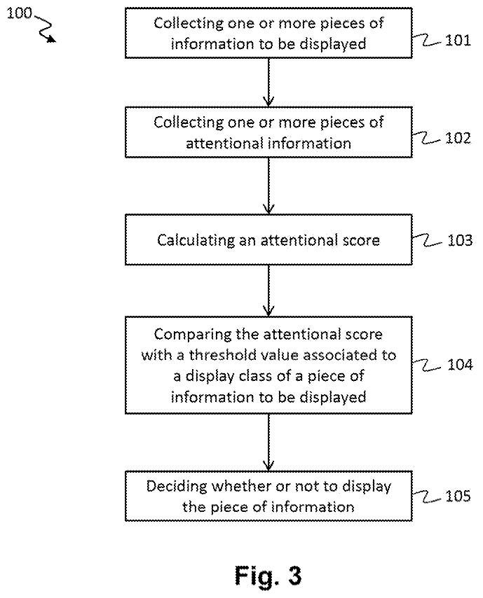

FIG. 3 diagrammatically shows the main steps of this decision-making method 100.

The method 100 includes in particular a step of collecting 101 one or more pieces of information to be displayed in the field of vision of the driver. As described hereinabove with reference to FIG. 1, the information to be displayed can originate from a variety of sources. Each piece of information to be displayed belongs to a display class of the table stored in the memory 21 of the device 20.

The method 100 further includes a step of collecting 102 one or more pieces of attentional information on the level of attention of the driver. As described hereinabove with reference to FIG. 2, the attentional information is acquired by one or more sensors 30 belonging to the device 20 or connected to the device 20.

The method 100 further includes a step of calculating 103 an attentional score representative of the level of attention of the driver from the collected pieces of attentional information.

For each piece of information to be displayed, the method 100 includes comparing 104 the calculated attentional score with the threshold value associated with the display class to which said piece of information to be displayed belongs, and deciding 105 whether or not to display said piece of information to be displayed based on the result of said comparison.

One example implementation of the method 100 is described hereinbelow. In this example, the attentional score is representative of the attention resources available to the driver for viewing information displayed in the field of vision thereof without compromising driving safety. The score takes a value between zero and one hundred. The higher the attentional score, the more information can be displayed within the field of vision of the driver. Conversely, the lower the attentional score, the more the information displayed within the field of vision of the driver should be limited to keep the driver focused on driving.

In this example, the table stored in the memory 21 of the device 20 contains the following display classes (the attentional score threshold value associated with each display class is also indicated):

TABLE 1

| | Attentional score |
|---|---|
| Display class: | threshold value: |
| Information on the condition of the | 0 |
| vehicle relevant to driving safety | |
| Navigation aid information | 10 |
| Notification of an incoming telephone | 30 |
| call | |
| Information about the music being | 50 |
| played | |
| Short text-based messages (SMS) | 60 |
| Long text-based messages (email, | 90 |
| news article or social network article) | |
| Video | 100 |

In the example considered, an attentional score of the driver is calculated by applying one or more multipliers respectively associated with the various attentional information collected. The multipliers associated with the various attentional information are listed in the table below for the example considered:

TABLE 2

| Attentional information: | Associated multiplier: |
|---|---|
| Night-time driving | 0.8 |
| Rainy conditions | 0.6 |
| Heavy traffic | 0.4 |
| Driver fatigue | 0.5 |
| Autonomous driving level 0 | 0.6 |
| Autonomous driving level 1 | 0.7 |
| Autonomous driving level 2 | 0.8 |
| Autonomous driving level 3 | 0.85 |
| Autonomous driving level 4 | 0.9 |

In the example considered, the attentional score of the driver is calculated by taking the value of one hundred and successively applying the various multipliers to be applied according to the attentional information collected. Moreover, when some pieces of attentional information are confirmed, the attentional score can take on a predetermined, fixed value (for example, when autonomous driving level 5 is detected, or when the vehicle is stopped at a red light, then the attentional score takes on the maximum value of one hundred). The table below gives various examples of scenarios and the attentional score associated therewith:

TABLE 3

| Number: | Scenario: | Attentional score: |
|---|---|---|
| #1 | Autonomous driving | 13.44 = 100 × |
| | level 1 at night, | 0.7 × 0.8 × |
| | in rainy weather, with heavy traffic | 0.6 × 0.4 |
| #2 | Autonomous driving level 0 in rainy | 18 = 100 × 0.6 × |
| | weather, with driver fatigue detected | 0.6 × 0.5 |
| #3 | Autonomous driving level 1 | 28 = 100 × |
| | with heavy traffic | 0.7 × 0.4 |
| #4 | Autonomous driving level 2 | 38.4 = 100 × 0.8 × |
| | at night, in rainy weather | 0.8 × 0.6 |
| #5 | Autonomous driving level 4 with | 45 = 100 × |
| | driver fatigue detected | 0.9 × 0.5 |
| #6 | Autonomous driving level 3 at night | 68 = 100 × 0.85 × 0.8 |
| #7 | Autonomous driving level 4 | 90 = 100 × 0.9 |
| #8 | Autonomous driving level 5 | 100 |
| #9 | Stopped (zero speed) at a red | 100 |
| | light or in a car park | |

The decision on whether or not to display a piece of information to be displayed within the field of vision of the driver is thus made by comparing the calculated attentional score value with the attentional score threshold value associated with said piece of information. The decision on whether to display is positive when the attentional score of the driver is greater than or equal to the attentional score threshold value associated with said information to be displayed. Conversely, the decision on whether to display is negative when the attentional score of the driver is strictly less than the attentional score threshold value associated with said information to be displayed.

Thus, in the example considered:
the decision on whether to display information on the operating status of the vehicle relevant to driving safety is positive in all scenarios considered (scenario #1 to #9),
the decision on whether to display navigation-aid information is positive in all scenarios considered (scenario #1 to #9),
the decision on whether to display a notification of an incoming telephone call is positive only for scenarios #4 to #9,
the decision on whether to display information about the music being played is positive only for scenarios #6 to #9,
the decision on whether to display a short text-based message (for example an SMS) is positive only for scenarios #6 to #9,
the decision on whether to display a long text-based message (for example an email or a news article) is positive only for scenarios #7 to #9,
the decision on whether to display a video is positive only for scenarios #8 and #9.

It should of course be noted that the example described hereinabove is highly simplified in order to briefly explain how an attentional score can be calculated and compared to threshold values associated with display classes. In reality, the number of display classes and/or the amount of attentional information collected can be far higher.

It should also be noted that various methods can be considered for calculating the attentional score of a driver based on the attentional information collected. The choice of a particular method for calculating the attentional score merely constitutes one alternative embodiment of the invention.

The decision on whether or not to display information can be updated recurrently, for example each time new information must be displayed, or each time a change in the attentional score of the driver is detected (for example if a sensor reports attentional information that causes a change in the calculation of the attentional score), or periodically.

In specific embodiments, the information to be displayed can be displayed on a screen integrated into the instrument panel of the vehicle. This can in particular include a Liquid Crystal Display (LCD), and more particularly a Thin Film Transistor (TFT) display, which can optionally be transparent. An LED (Light-Emitting Diode) or OLED (Organic Light-Emitting Diode) screen that is optionally transparent can also be used.

In specific embodiments, and as illustrated in FIG. 2, the device 20 further includes an image generator 24 adapted to generate a virtual image using a transparent projection medium of a head-up display. The image thus contains the information to be displayed for which the decision on whether to display is positive. The image generator comprises, for example, a light source and micro-mirrors of an electronic circuit of the DLP (digital light processing) type.

The invention further relates to a head-up display including a device 20 with an image generator 24, and a transparent projection medium towards which an image generated by the image generator 24 is projected to form a virtual image that appears behind the transparent projection medium to the driver.

The transparent projection medium can correspond to the windscreen of the vehicle 10. According to another example, this can be a transparent projection screen placed between the driver and the windscreen (“combiner”). In specific embodiments, the transparent projection medium is a visor or a screen of a helmet or a mask, or an eyeglass lens.

In specific embodiments, the transparent projection medium is a transparent screen (“combiner”) placed between the eyes of the driver and the visor or screen of a helmet or a mask worn by the driver.

It is clear from the above description that the present invention, with its various features and their advantages, achieves its objectives of providing a solution for displaying as much information as possible to a driver of a means of locomotion while guaranteeing driving safety.

Generally speaking, it should be noted that the implementations and embodiments considered above have been described by way of non-limiting examples in the case where the means of locomotion are a motor vehicle. However, the invention can be applied to any type of means of locomotion (in particular for a ship, aeroplane, space shuttle, underwater vehicle, etc.) as long as information can be displayed to the driver of said means of locomotion on an on-board screen of the means of locomotion or via a head-up display device.

According to further examples, if a head-up display is used with a helmet visor acting as the transparent projection medium, the means of locomotion can be a motorbike or a moped. If a head-up display is used with a helmet screen acting as the transparent projection medium, the means of locomotion can be a scuba diving suit or a spacesuit. If a head-up display is used with a lens of a pair of goggles acting as the transparent projection medium, the means of locomotion can be a pair of skis or a snowboard. If a head-up display is used with a lens of a pair of spectacles acting as the transparent projection medium, the means of locomotion can be a bicycle or a scooter, etc.

On the other hand, the examples given in the description for the information to be displayed, for the display classes, for the attentional information considered and/or for the method for calculating the attentional score, are by no means limiting. Other information to be displayed, other display classes, other attentional information and/or other methods for calculating an attentional score could thus be considered in order to implement the invention. The nature of the information to be displayed can depend, in particular, on the means of locomotion considered.

1-14. (canceled)

15. A device to control the display of information in a field of vision of a driver of means of locomotion, comprising a memory to store a table associating different display classes with respective threshold values of an attentional score representative of a level of attention of the driver; and at least one processor configured to:
collect one or more pieces of information to be displayed in the field of vision of the driver, each piece of information to be displayed belonging to a display class from the table;
collect one or more pieces of attentional information relating to the level of attention of the driver;
calculate an attentional score representative of the level of attention of the driver from the collected pieces of attentional information;
for each piece of information to be displayed:
compare the attentional score to a threshold value associated with the display class to which said each piece of information to be displayed belongs to provide a comparison result; and
determine whether or not to display said each piece of information to be displayed based on the comparison result.

16. The device of claim 15, further comprising at least one sensor to acquire attentional information relating to the level of attention of the driver.

17. The device of claim 15, further comprising a communication module to receive at least one piece of attentional information acquired by a sensor belonging to an entity that is separate from the device.

18. The device of claim 15, wherein, when there are several pieces of information to be displayed, said at least one processor is further configured to order the pieces of information to be displayed by an order of priority, and to successively make determinations according to the order of priority whether or not to display said each piece of information.

19. The device of claim 15, further comprising an image generator configured to generate an image to be projected onto a transparent projection medium to form a virtual image appearing behind the projection medium for the driver, the image comprising a piece of information to be displayed for which the determination on whether to display is positive.

20. A head-up display comprising the device of claim 19 and a transparent projection medium.

21. The head-up display of claim 20, wherein the transparent projection medium is a windscreen of a vehicle, or a transparent projection screen placed between the driver and the windscreen.

22. The head-up display of claim 20, wherein the transparent projection medium is a visor or a screen of a helmet or a mask, or an eyeglass lens.

23. A method implementing the device of claim 15 to control the display of the information in the field of vision of the driver of the means of locomotion.

24. The method of claim 23, wherein each piece of attentional information is representative of a physiological or psychological state of the driver, of an operating state of the means of locomotion, or of environmental conditions outside the means of locomotion.

25. The method of claim 23, wherein a display class corresponds to one of the following classes:
information on an operating status of the means of locomotion relevant to a driving safety,
information on environmental conditions outside the means of locomotion and relevant to the driving safety,
information on the operating status of the means of locomotion not relevant to the driving safety,
information on the environmental conditions outside the means of locomotion and not relevant to the driving safety,
navigation information,
a notification of an incoming telephone call,
a short text-based message,
an email message,
information about the music being played,
social network articles, and
a video.

26. The method of claim 23, wherein the attentional score is representative of a level of attention available to the driver for viewing the information displayed in the field of vision thereof without compromising the safe driving of the means of locomotion.

27. The method of claim 23, wherein the determination on whether to display a piece of information to be displayed is positive when the attentional score is greater than or equal to the threshold value associated with the display class to which the piece of information to be displayed belongs.

28. The method of claim 23, wherein, when there are several pieces of information to be displayed, the pieces of information to be displayed are ordered by an order of priority, and the determinations whether or not to display said each piece of information are made successively according to the order of priority.

29. A computer-readable medium storage comprising code instructions to configure a processor to implement the method of claim of claim 23.
